(19) United States
(12) Patent Application Publication
(10) Pub. No.: US 2021/0169268 A1
(43) Pub. Date: Jun. 10, 2021

(54) AUTOMATIC APPARATUS FOR THE PRODUCTION AND COOKING OF TORTILLAS OR SIMILAR PRODUCTS

(71) Applicant: Blanca Laura VAZQUEZ AGUILERA, Zapopan (MX)

(72) Inventor: Blanca Laura VAZQUEZ AGUILERA, Zapopan (MX)

(21) Appl. No.: 17/270,273

(22) PCT Filed: Apr. 22, 2019
(86) PCT No.: PCT/MX2019/000039

§ 371 Date: Feb. 22, 2021

(30) Foreign Application Priority Data
Aug. 22, 2018 (MX) MX/A/2018/010127

(51) Int. Cl. A47J 37/06; A21B 5/03

(52) U.S. Cl. CPC A47J 37/0611; A21B 5/03

(57) ABSTRACT

The present invention consists of an automatic apparatus for the production and cooking (50) of tortillas, which comprises a cartridge (1, 54, 71), which contains raw or partially cooked tortillas (21) pre-formed in a circle, a coupling system to easily attach and remove the cartridge (1, 54, 71) and an automatic cooking system (2) consisting of two parallel griddles or also called comales (11, 12), each griddle configured to cook each side of the tortilla and dispensing the tortilla to a container (10) after completing a cooking cycle by means of a specific movement of the griddles (11, 12) controlled by a microcomputer.

### TECHNICAL FIELD OF THE INVENTION

The present invention relates to machines for producing and cooking tortillas automatically. More specifically, the present invention relates to an automatic tortilla dispensing and cooking apparatus.

### BACKGROUND OF THE INVENTION

The tortilla is one of the most important foods in Mexico. Its consumption dates from pre-Hispanic civilizations, that used the metate as an instrument for grinding the nixtamal and they also used a hot flat surface to cook tortillas manually. Currently, industrial processes are used for the grinding, forming, cooking and storage of tortillas. There are a large number of establishments in urban and rural areas where it is possible to purchase tortillas, whether they are convenience stores, self-service stores or establishments specifically dedicated to their production and sale. The product is acquired in a fully cooked form, either hot or cold, and is a food that is rarely fully made at home today. Due to the industrialization of the tortilla making processes, it is possible to perceive a deficiency in flavor, texture and consistency in tortillas made in an industrial way, compared to tortillas made in a traditional way. The present invention solves this problem with an apparatus that emulates the traditional tortilla cooking process by means of a compact mechanism that manipulates the tortilla in a cooking process similar to a human hand.

Automatic tortilla production machines have been developed since the beginning of the 20th century. Currently there is a great variety of said machines in terms of the formation and production capacity of tortillas, although the way of cooking is maintained either on a griddle, commonly referred to as a “comal,” or in an oven system. The traditional way of cooking tortillas is using a comal, for this reason the machines that use ovens to make tortillas simply differ in the traditional result. The machine described in U.S. Pat. No. 5,918,533 is an example of a large capacity automatic machine that uses an oven system and consists of a system for making tortillas that includes a sheeter, a roller/heater, and an oven. In such a system, the tortillas are cut into an oblong shape on the sheeter and the roller/heater kneads the tortillas into a round shape and conductively heats the tortillas simultaneously on the top and bottom surfaces, gelatinizing the food product and sealing in moisture. The tortillas are then cooked in an oven. Tortilla marks and grooves are avoided because the heater/roller has continuous top and bottom belts that have continuous surfaces.

In turn, the machine described in U.S. Pat. No. 4,508,025 is designed with a system of concentric griddles that allow the cooking of each side of the tortilla based on gravity and rotary movements, which fulfills the objective of resembling the process traditional cooking, but it takes up a lot of space and consumes large amounts of energy due to the number of hot surfaces and moving parts.

Recently, a new type of tortilla machine has emerged, aimed at the home appliance market. Patent application US 2015/0044340 A1 is an example of this type of machine, which includes a system that opens tortilla dough capsules to later form the tortilla and cook it completely automatically. The system of the aforementioned application seeks to facilitate the preparation of freshly made tortillas at home, but its cooking design, composed of two hot surfaces to cook both sides of the tortilla simultaneously, does not allow obtaining a tortilla with characteristics similar to those of a tortilla made in a traditional way. Additionally, the capsules of patent application US 2015/0044340 A1 comprise non-preformed mass, which means that the apparatus of said application requires a pressing system, which obviously increases the cost of the apparatus and its dimensions. On the other hand, the cooking system is different from that of the present invention.

The patent application MX/a/2016/009369 belonging to the applicant of the present invention describes a packaging and dispensing device for tortillas that describes an automatic dispenser for pre-formed tortillas contained in a cartridge, but the cartridge comprises different separate elements for its correct operation such as a belt connected to the engine and a traction cylinder. On the other hand, the present invention comprises a cartridge with a coupling system and integrated elements in a compact and integral way, while eliminating some separate elements such as the band. In addition, the patent application MX/a/2016/009369 is completely silent with respect to the cooking system and/or a cartridge shaft integrated in the cartridge housing and it is also completely silent with respect to the fact that the cartridge is removable, that is, The present invention allows the cartridges to be removed in such a way that once the preformed tortillas in one of the cartridges has been depleted, another cartridge can be quickly mounted to a base to continue tortilla production.

In addition, taking into account migratory movements and the globalization of markets, the number of consumers looking for a high quality tortilla, but at the same time with that traditional touch has increased internationally, mainly in the North American market, therefore that the present invention is a perfect solution for that market and its consumers. It is important to note that there are also products similar in appearance, ingredients and elaboration processes to the Mexican tortilla, such as chapati, roti, naan, pita, etc., which are consumed in other parts of the world and due to their similarity, said products can also be prepared and/or cooked using the apparatus described in the present invention.

### BRIEF DESCRIPTION OF THE INVENTION

The present invention consists of an automatic apparatus for the production and cooking of tortillas, which essentially consists of:

a cartridge, which contains pre-formed circular tortillas that are not fully cooked, a cartridge attachment system and an automatic cooking system consisting of two parallel griddles or also called comales, each griddle configured to cook each side of the tortilla and dispense the tortilla into a container after completing a cooking cycle using a specific movement of the comales.

### BRIEF DESCRIPTION OF THE FIGURES

The present invention will be better understood by referring to the detailed explanation of the present description when read in conjunction with the accompanying figures, where:

FIG. 1 is a rear perspective view of the tortilla making and cooking apparatus without an inserted tortilla cartridge;

FIG. 2 is a rear perspective view of the inserted cartridge of the tortilla making and cooking apparatus;

FIG. 3 is a side view of the apparatus of the present invention;

FIG. 4 is a view from the rear of the apparatus of the present invention;

FIG. 5 is a top view of the apparatus of the present invention;

FIG. 6 is a perspective view showing a preferred embodiment of a flat cartridge containing partially cooked tortillas for dispensing;

FIG. 7 is a side sectional view showing the internal parts of the flat cartridge of FIG. 6 and the distribution of partially cooked tortillas;

FIG. 8 is a side view of the flat cartridge showing a flat cartridge engagement mechanism;

FIG. 9 shows the engagement of a cartridge shaft that rewinds films within the flat tortilla cartridge;

FIG. 10 shows the linear distribution of the partially cooked tortillas that are inserted into the flat cartridge;

FIG. 11 shows the flat cartridge of FIG. 6 pushing the films causing the partially cooked tortilla to come out;

FIG. 12 shows a perspective view of another preferred embodiment of a cylindrical cartridge;

FIG. 13 shows a side view of the cylindrical cartridge of FIG. 12;

FIG. 14 shows a side sectional view of the cylindrical cartridge of FIG. 12;

FIG. 15 shows a perspective view of the cylindrical cartridge of FIG. 12 simulating the way in which a partially cooked tortilla is ejected;

FIG. 16 shows a side sectional view of the cylindrical cartridge of FIG. 12 attached to a manual feeder;

FIG. 17 shows a perspective view of the apparatus for the production and cooking of tortillas of the present invention directly connected to the cylindrical cartridge;

FIG. 18 shows a perspective view of a preferred embodiment of the flat cartridge;

FIG. 19 shows a side sectional view showing the internal parts of the flat cartridge embodiment of FIG. 18 and the distribution of the tortillas; Y

FIG. 20 shows a film rewind cartridge shaft coupling within the preferred embodiment of the flat tortilla cartridge of FIG. 18.

### DETAILED DESCRIPTION OF THE INVENTION

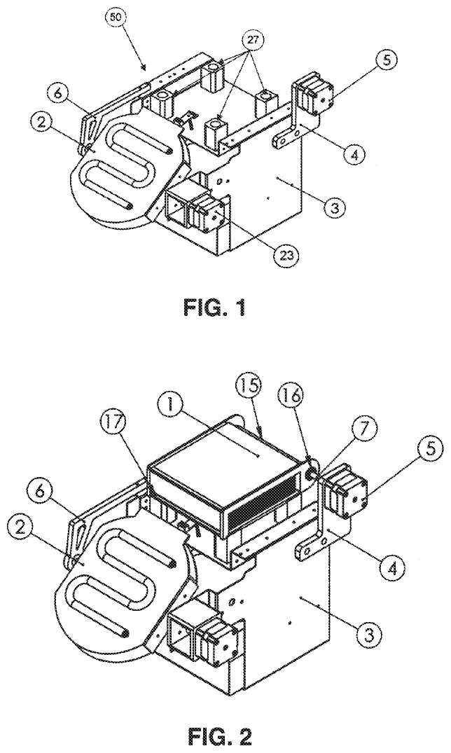

Referring to FIGS. 1 and 2, the tortilla production and cooking apparatus 50 of the present invention is shown, which comprises a base 27, a cooking system 2, and a machine structure 3. The base 27 is configured to receive a flat cartridge 1 which contains raw, partially cooked tortillas 21 or similar products, the flat cartridge 1 being placed manually by a user on the base 27. The flat cartridge 1 is mechanically attached to the cartridge drive motor 5 by means of a cartridge coupling 16, wherein one end of a motor coupling 7 is frictionally inserted into cartridge coupling 16, while another end of motor coupling 7 is coupled to a cartridge drive motor 5, the Cartridge drive motor 5 is attached to a side portion of the machine frame 3 through a cartridge motor bracket 4. When rotating, the cartridge drive motor 5 causes the motor coupling 7 and the cartridge coupling 16 to rotate, cartridge coupling 16 forms part of the cartridge shaft 15.

The cooking system 2 is coupled to a lower griddle shaft 52 (see FIG. 4), one end of the lower griddle shaft 52 being coupled to a griddle motor 23 through a mechanical coupling 14 and the other end coupled to a griddle support 6 by means of a pillow block (not shown) which allows the rotation of the cooking system 2 on its own axis, the griddle support 6 being fixed to the machine structure 3. The cooking system 2 is configured to receive a tortilla 21 and cook it on both sides after the tortilla 21 is dispensed from the flat cartridge 1.

The comal motor 23 can be selected from any of a direct current (DC) motor, an alternating current (AC) motor, a stepper motor, a servo motor, or any other suitable motor.

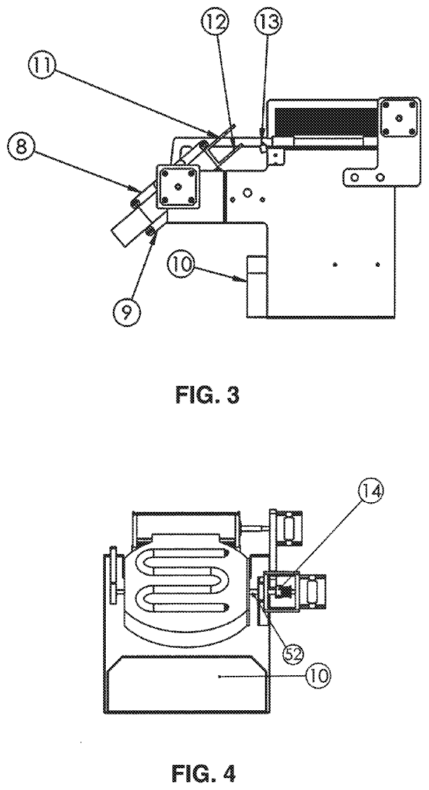

With reference to FIGS. 3 and 4, it can be seen that the cooking system 2 comprises an upper griddle 11 and a lower griddle 12, both griddles 11, 12 being joined together by means of fastening elements, such as, but not limited to, screws. The upper 11 and lower 12 griddles are configured to receive a partially cooked tortilla 21 and cook the upper and lower sides thereof. The upper 11 and lower 12 griddle surfaces are made of a non-stick material so that the tortilla 21 does not stick to the system 2 during the cooking process. The cooking system 2 also comprises an upper thermal resistance 8 and a lower thermal resistance 9. The upper heating element 8 is fixed to the upper griddle 11, while the heating element 9 is fixed to the lower griddle 12. The function of both heating elements is to heat each of the upper 11 and lower 12 griddles to a suitable cooking temperature of between 190-240° C. and keep that temperature constant. Temperature control is performed by a microcomputer (not shown) electrically connected to heating elements 8, 9. The microcomputer can be selected from any of, but not limited to, a processor, a controller, programmable logic circuits, etc.

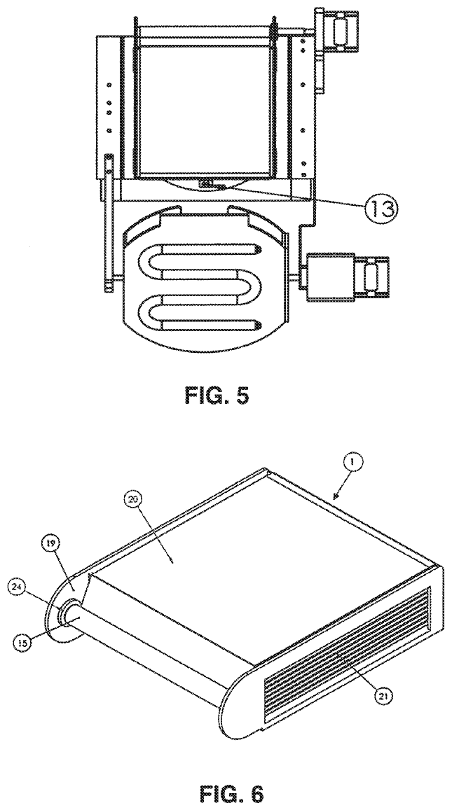

As can be seen from FIG. 5, the apparatus for the production and cooking of tortillas 50 of the present invention further comprises a tortilla sensor 13, which is electrically connected to the microcomputer. The tortilla sensor 13 is attached to an upper portion of the machine structure 3 and has the objective of detecting the presence of a partially cooked tortilla 21 that is dispensed from the flat cartridge 1. The tortilla sensor 13 being an optical sensor.

The tortilla 21 is dispensed from the flat cartridge 1 by means of the action of the cartridge drive motor 5, the cartridge drive motor 5 being controlled by the microcomputer. The microcomputer is configured to read the status of the tortilla sensor 13 and determines that the partially cooked tortilla 21 is being transported to the lower griddle 12, identifying its presence through the tortilla sensor 13 and once the sensor 13 is no longer interrupted it is determined that the partially cooked tortilla 21 has completely come out of the flat cartridge 1.

The microcomputer is also configured to control the cooking of tortilla 21, through the following cycle:

detecting the presence of a partially cooked tortilla 21, by means of the tortilla sensor 13, and rotating the cooking system 2 by 45° to receive the partially cooked tortilla 21 and start cooking one of its faces;

rotate cooking system 2 to 0° to cook the underside of tortilla 21 for 10-15 seconds;

rotate 180° the cooking system 2 for 20-25 seconds, when the face of the tortilla is cooked, to place the upper face of the tortilla 21 in contact with the upper griddle 11;

rotate the cooking system 2 again to 0°, when the face of the tortilla is cooked, once again placing the lower face of the tortilla 21 in contact with the lower griddle 12 for 20-seconds; and tilting the cooking system 2 towards a tortilla container 10 to deposit a cooked tortilla 21, where the cooked tortilla 21 slides under the action of gravity completing the cooking cycle.

The tortilla container 10 is placed in a lower portion of the machine structure 3 and as previously mentioned it aims to receive a cooked tortilla 21 from the cooking system 2, wherein the cooked tortilla 21 slides into the container 10 through the action of gravity and rotation of the cooking system 2.

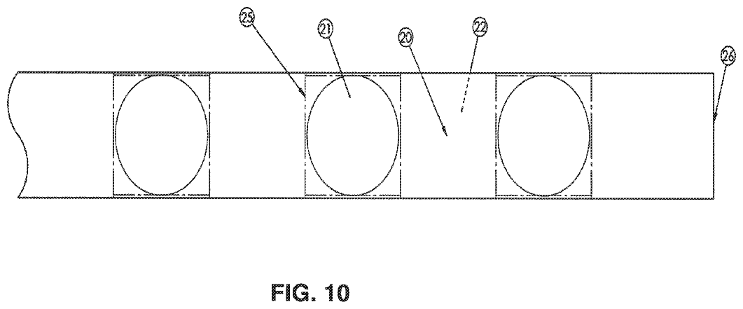

Now, in FIGS. 6 to 8 and 11, a preferred embodiment of the flat cartridge 1 of the present invention can be observed in more detail, where the flat cartridge 1 is made up of a cartridge housing 19 which contains tortillas 21, each tortilla 21 packed by a lower film 20 and an upper film 22, wherein the lower film 20 and the upper film 22 are fused to a cartridge shaft 15 through a film edge 26 (see FIG. 10), at where the cartridge shaft 15 is configured to transport a partially cooked tortilla 21 towards a cartridge slot 17, by means of the action of the cartridge motor 5, the cartridge slot 17 allows the exit of a tortilla 21 towards the cooking system 2. The lower 20 and upper 22 film are further configured to act as an oxygen barrier and protection against microorganisms. The lower film 20 and the upper film 22 are hermetically joined by a seal 25 (see FIG. 10) formed by the adhesion between both films.

It should be noted that the seal 25 can be selected from any of, but not limited to, plastic, wax paper, or a double-layered film consisting of paper and plastic, or any combination of the previously mentioned materials.

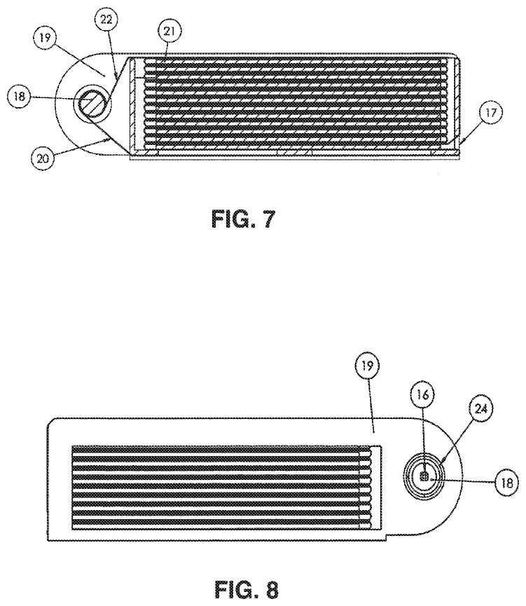

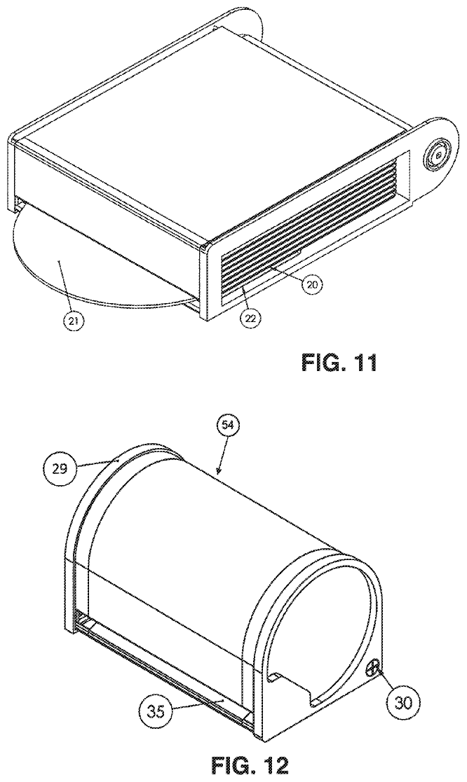

The cartridge shaft 15 when rotating winds the lower film 20 and the upper film 22, both films come out of the slot 17, the film 22 slides on the upper part of the flat cartridge 1 and the lower film 20 slides on the lower part of the flat cartridge 1 (see FIG. 7), which causes the tortilla seal 25 to come off when separating both films, in turn allowing the tortilla 21 to be ejected into the slot 17 as shown in FIG. 11.

Cartridge shaft 15 is inserted into a cartridge pivot 18 which forms part of cartridge housing 19, the cartridge pivot 18 being configured to press-receive cartridge shaft 15 and rotate freely. The cartridge pivot 18 comprises a cartridge mechanical coupling 16 and a cartridge hole 24, the cartridge mechanical coupling 16 is part of the cartridge shaft 15 and allows the motor coupling 7 to be joined to the cartridge shaft 15, and said joint allows the rotation of the cartridge shaft 15 when the cartridge drive motor 5 is in motion, thus allowing the upper film 22 and the lower film 20 to be rolled up.

Cartridge hole 24 is configured to direct cartridge shaft toward cartridge pivot 18, as well as ensuring that cartridge shaft 15 does not slip out of place.

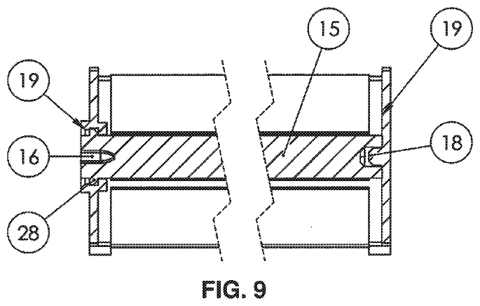

FIG. 9 shows the cartridge shaft 15 properly coupled to the housing 19 through the cartridge pivot 18 which is located at one end of the housing 19, while at the other end of the housing 19, the cartridge shaft 15 it is secured to a cartridge coupling 16 through a latch 28. The latch 28 prevents shaft 15 from slipping out of place once inserted.

The above configuration allows the flat cartridge 1 to be easily removed and/or placed and also allows the flat cartridge 1 to be securely fixed on the base 27 to avoid any inconvenience during the operation of the apparatus for production and cooking of tortillas 50 of the present invention.

The housing 19 can be made of plastic or any other suitable material.

Referring to FIG. 10, the arrangement of the tortillas 21 packed by the lower film 20 and the upper film 22 and joined by means of the seal 25 is shown. The seal 25 protects the tortillas against moisture, contaminating agents, microorganisms or others. agents. Seal 25 is configured to peel off using a film edge 26 that is fused to cartridge shaft 15, where film edge 26 is pulled by cartridge shaft 15 thus detaching seal 25 as lower 20 and upper film 22 are wound by the cartridge shaft 15 and ejected towards the slot 17. The partially precooked tortilla 21 once released from its seal 25 is transported towards the cooking system 2.

Seal 25 can also contain an oxygen barrier, inert atmosphere, or be under vacuum.

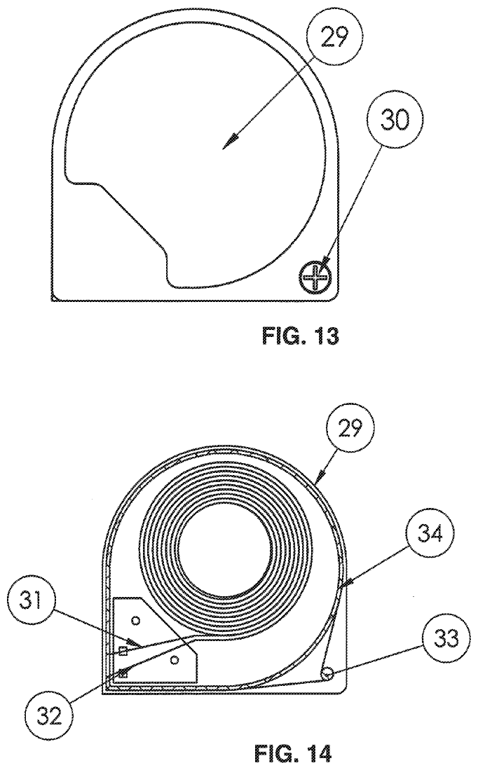

FIGS. 12 to 16 show a preferred embodiment of a cylindrical cartridge 54 containing partially precooked tortillas 21. The cylindrical cartridge 54 comprises a cylindrical cartridge cap 29 in a cylindrical shape, the cylindrical cartridge cap 29 being press fit to a cylindrical cartridge housing 34.

The cartridge housing 34 comprises a cylindrical cartridge upper film 31 which is fused to a cartridge shaft 33 through a film edge 26, the upper film 31 allowing the transport of the tortilla 21 into a cartridge slot 35. The upper cylindrical cartridge film 31 is joined with a lower cylindrical cartridge film 32 in order to form a seal 25 thus containing a tortilla 21.

The cylindrical cartridge 54 further comprises a cylindrical cartridge coupling 30 which is part of a cartridge shaft 33 and allows the motor coupling 7 to be connected to the cartridge shaft 33, allowing the turning or rotation of the cartridge shaft 33 when the traction motor for cartridge 5 is in motion.

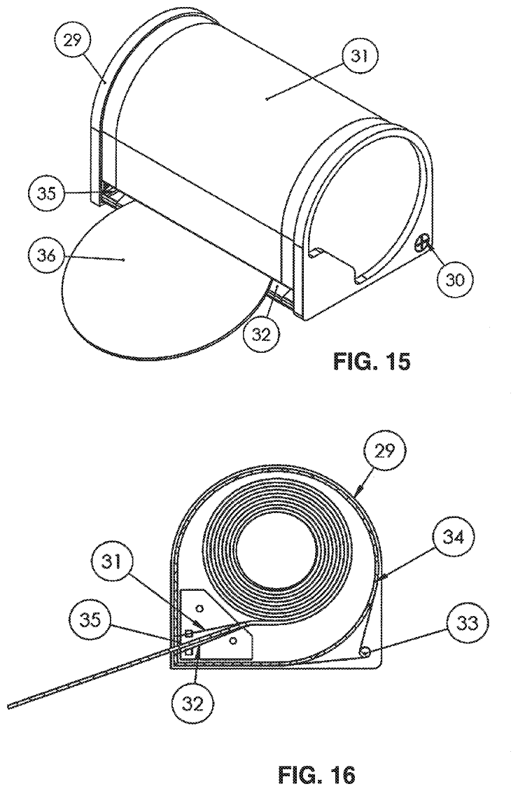

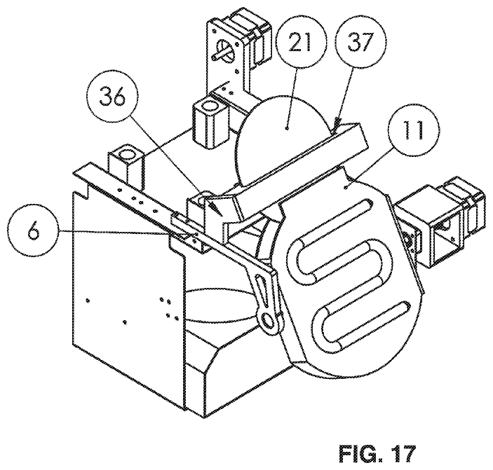

The cartridge shaft 33 when rotating, it winds the lower film 32 and the upper film 31, both films come out of the slot 35, the film 31 slides on the upper part of the cylindrical cartridge 54 and the lower film 32 slides on the lower part of the cylindrical cartridge 54 (see FIG. 14), which causes the tortilla seal 25 to come off when separating both films, allowing the tortilla 21 to be ejected into the slot 35 as shown in FIG. 15. The cartridge shaft 33 it also comprises a cartridge pivot (18) that has a function similar to that described in FIG. 9.

A manual feeder 36 is attached to the griddle support 6 and to the machine structure 3 and its function is to receive tortillas so that they can be heated or cooked by the cooking system 2.

It should be noted that the manner of detaching the seal on the cylindrical cartridge 54 is similar to that described in FIG. 10, with the only thing that changes is the reference number for the upper and lower film for the present embodiment.

As can be seen from FIG. 10, the partially precooked tortilla 21 is fed into a manual feeder inlet 37 which directs the tortilla 21 towards the cooking system 2.

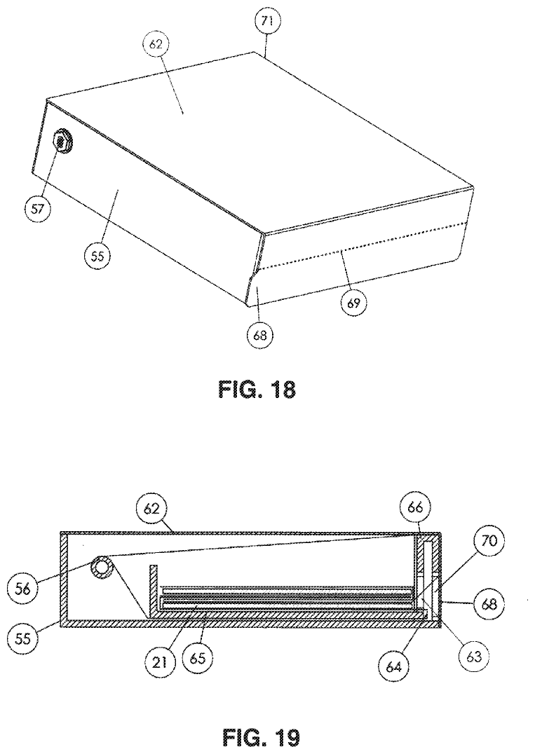

Now, referring to FIGS. 18 to 20, a preferred embodiment of a flat cartridge 71 can be observed, wherein the flat cartridge 71 is made up of a cartridge housing 55 which comprises a cartridge cap 62 attached to the housing of cartridge 55.

The cartridge cap 62 integrates a removable flange 68 at one end, the removable flange 62 being configured to be manually detached by a user along a dotted line of holes 69, which allows the tortilla 21 to exit through a slot 70, when the tortilla making and cooking apparatus 50 is in operation.

The housing 55 contains tortillas 21, each tortilla 21 is packed by a lower film 64 and an upper film 63, wherein the lower film 64 is fused to a cartridge shaft 56 through a film edge 26 (see FIG. 10), wherein the cartridge shaft 56 is configured to transport a partially cooked tortilla 21 into a cartridge slot 70, when the cartridge motor 5 is operating, the cartridge slot 70 allows a tortilla 21 to exit into the cooking system 2. The bottom 64 and top 63 film are further configured to act as an oxygen barrier and protection against microorganisms. The lower film 64 and the upper film 63 are hermetically joined by means of a seal 25 (see FIG. 10) formed by the adhesion between both films.

It should be noted that the seal 25 can be selected from any of, but not limited to, plastic, wax paper, or a double-layered film consisting of paper and plastic, or any combination of the previously mentioned materials.

As the cartridge shaft 56 rotates, it winds the lower film 64 and the upper film 63, both films come out of the slot 70, the upper film 63 slides over an upper portion of the flat cartridge 71 and passes over a nearby double-walled reinforcement 66 to the removable flange 68, while the lower film 64 slides between a lower portion of the flat cartridge 71 and a tortilla base 65 (see FIG. 19), which causes the tortilla seal 25 to come off when separating both films, in turn allowing the tortilla 21 to exit towards the slot 70. The double wall reinforcement 66 is adapted to withstand the tension of the upper film 63 and prevent the tortillas 21 from accidentally exiting the flat cartridge 71 once the flange 68 is removed and ensuring that the exit of the tortillas 21 is solely by the action of the motor 5 when it is operating.

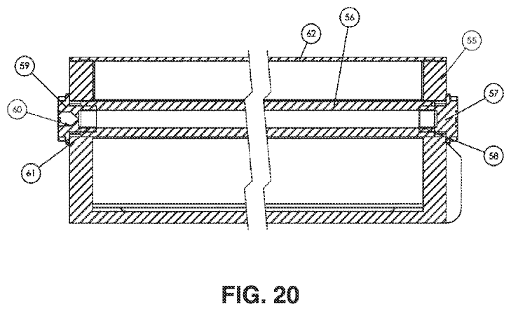

The cartridge shaft 56, which comprises a tubular shape, is supported at one end by a pull plug 59 and at the opposite end by a guide plug 57, the pull plug 59 and the guide plug 57 form a pivot 61 and 62, said pivots are snap fitted to a cartridge shaft 56. Pull plug 59 and guide plug 57 are snap inserted into housing 55 as can be seen from FIG. 20, allowing the plugs to rotate freely. A cartridge mechanical coupling 60 is part of the pull plug 59 and allows the motor coupling 7 to be attached to the cartridge shaft 56, and said joint allows the rotation of the cartridge shaft 56 when the cartridge drive motor 5 is in motion, thus allowing the upper film 63 and the lower film 64 to be rolled up.

The above configuration allows the flat cartridge 71 to be easily removed and/or placed and also allows the flat cartridge 71 to be securely fixed on the base 27 to avoid any inconvenience during the operation of the tortilla production and cooking apparatus 50 of the present invention.

The double-walled backing 66 and the tortilla base 65 are integral with the housing 55 and are manufactured from a single folded and glued cardboard section.

It should be noted that, although in the present description, it has been explained that the product is a raw, partially cooked or fully cooked tortilla, one skilled in the art will understand that the present invention is not limited to a tortilla, and other products can be cooked similar, such as, but not limited to chapati, roti, naan, pita, among others.

It is noted that in relation to this date, the best method known to the applicant for putting the aforementioned invention into practice is the one that is clear from the present description of the invention.

1. A removable flat cartridge to house preformed tortillas, characterized in that it comprises:
a cartridge housing to contain the preformed tortillas, the preformed tortillas are packed in a hermetic seal formed by a lower film and an upper film;
an outer cartridge shaft snap-fitted between a cartridge pivot located at one end of the housing and a cartridge mechanical coupling located at an opposite end; and
wherein the lower film and the upper film are fused to the cartridge shaft through a film edge and wherein the cartridge shaft is configured to remove the seal hermetic and transport the preformed tortillas into a cartridge slot.

2. The flat cartridge according to claim 1, characterized in that the hermetic seal comprises an oxygen barrier and protection against microorganisms.

3. The flat cartridge according to claim 1, characterized in that the housing is made of plastic.

4. The flat cartridge according to claim 1, characterized in that the cartridge mechanical coupling further comprises a lock.

5. The flat cartridge according to claim 1, characterized in that the cartridge pivot further comprises a cartridge hole configured to direct the cartridge axis towards the cartridge pivot.

6. The flat cartridge according to claim 1, characterized in that the hermetic seal can be selected from plastic, waxed paper, or a double-layer film formed by paper and plastic.

7. A removable cylindrical cartridge to contain preformed tortillas, characterized in that it comprises:
a cylindrical cartridge cap that is snap attached to a cartridge housing;
the cartridge housing to contain the preformed tortillas, the preformed tortillas are packed in a hermetic seal formed by a lower film and an upper film;
an internal cartridge shaft snap-fitted between a cartridge pivot located at one end of the housing and a cartridge mechanical coupling located at an opposite end; and
wherein the lower film is fused to the cartridge shaft through a film edge and wherein the cartridge shaft is configured to remove the hermetic seal and transport the tortillas preformed into a cartridge slot.

8. The cylindrical cartridge according to claim 7, characterized in that the hermetic seal comprises an oxygen barrier and protection against microorganisms.

9. The cylindrical cartridge according to claim 7, characterized in that the housing is made of plastic.

10. The cylindrical cartridge according to claim 7, characterized in that the cartridge mechanical coupling further comprises a lock.

11. The cylindrical cartridge according to claim 7, characterized in that the cartridge pivot further comprises a cartridge hole configured to direct the cartridge axis towards the cartridge pivot.

12. The cylindrical cartridge according to claim 7, characterized in that the cartridge further comprises a cylindrical cartridge coupling directly attached to the cartridge shaft.

13. The cylindrical cartridge according to claim 7, characterized in that the hermetic seal can be selected from plastic, waxed paper, or a double-layer film formed by paper and plastic.

14. A removable flat cartridge to contain preformed tortillas, characterized in that it comprises:
a cartridge housing for containing the preformed tortillas, the preformed tortillas are packed in an airtight seal formed by a lower film and an upper film;
a tubular shaped cartridge shaft, the cartridge shaft being supported at one end by a pull plug and at an opposite end by a guide plug;
wherein the lower film and the upper film are fused to the cartridge shaft through a film edge,
wherein the cartridge shaft is configured to remove the hermetic seal and transport the preformed tortillas into a cartridge slot,
wherein the cartridge housing comprises a cartridge cap, the cartridge cap including a removable flange through a dotted line of holes.

15. The flat cartridge according to claim 14, characterized in that it also comprises a traction cap and a guide cap that form a pivot and a pivot respectively.

16. The flat cartridge according to claim 15, characterized in that the traction and the guide pivot are configured to snap-fit the cartridge shaft with the housing.

17. The flat cartridge according to claim 14, characterized in that it also comprises a
cartridge mechanical coupling that is part of the traction cap.

18. The flat cartridge according to claim 14, characterized in that the cartridge further comprises a double-walled reinforcement and a tortilla base and a housing integrated as a single piece.

19. The flat cartridge according to claim 14, characterized in that the hermetic seal comprises an oxygen barrier and protection against microorganisms.

20. The flat cartridge according to claim 14, characterized in that the housing is made of cardboard.

21. The flat cartridge according to claim 19, characterized in that the hermetic seal can be selected from plastic, waxed paper, or a double-layer film formed by paper and plastic.

22. An automatic apparatus for the production and cooking of tortillas, characterized in that it comprises:
a microcomputer;
a machine structure;
a base configured to receive a cartridge with preformed tortillas; and
a cooking system, where one end of the cooking system is coupled to a comal motor through a comal shaft and another end is coupled to a comal support of the machine structure through a pillow block;
wherein the cartridge is mechanically joined to a cartridge motor by means of a motor coupling, the motor being connected to both a cartridge traction motor as well as a cartridge coupling which connects to a cartridge shaft of the cartridge to roll up and remove a hermetic seal,
wherein the cooking system comprises an upper griddle with an upper side heating element and a lower griddle with a lower side heating element, the griddles being joined together by means of fastening elements and being parallel to each other,
wherein the microcomputer is electrically connected to the motors, to the heating elements and to a sensor fixed to an upper portion of the machine structure.

23. The apparatus according to claim 22, characterized in that the microcomputer can be selected from a processor, a controller or programmable logic circuits.

24. The apparatus according to claim 22, characterized in that the motors can be selected from a direct current motor, an alternating current motor, a stepper motor, a servomotor or a combination of the above.

25. The apparatus according to claim 22, characterized in that the microcomputer is further configured to detecting a presence of a tortilla by means of the tortilla sensor, and rotating the cooking system 45° to receive the tortilla and start cooking one of its faces;
rotate the cooking system to 0° to cook the underside of the tortilla for 10-15 seconds;
rotate 180° the cooking system for 20-25 seconds to place an upper face of the tortilla in contact with the upper griddle;
rotate the cooking system again to 0°, once again placing the lower face of the tortilla in contact with the lower griddle for 20-30 seconds; and
Tilt the cooking system towards a tortilla container to deposit a cooked tortilla.

26. The apparatus according to claim 25, characterized in that the sensor is an optical sensor.

27. The apparatus according to claim 22, characterized in that the upper and lower griddle are made of a non-stick material.
